(19) United States
(12) Patent Application Publication
(10) Pub. No.: US 2011/0219643 A1
(43) Pub. Date: Sep. 15, 2011

(54) OUTSOLE WITH AN EMBEDDED FABRIC LAYER AND METHOD OF MANUFACTURING THE SAME

(75) Inventor: Chin-Hsing TAI, Taichung (TW)

(73) Assignee: TREASURY CO., LTD., Taichung (TW)

(21) Appl. No.: 13/110,831

(22) Filed: May 18, 2011

Related U.S. Application Data
(63) Continuation-in-part of application No. 11/951,606, filed on Dec. 6, 2007.

(30) Foreign Application Priority Data
Apr. 29, 2007 (CN) 200720148636.6

(51) Int. Cl. A43B 13/14; B05D 3/12

(52) U.S. Cl. 36/25 R; 427/370

(57) ABSTRACT

A method of manufacturing an outsole with an embedded fabric layer includes a preparing step, a forming step and a separating step. The preparing step includes preparing two molds, a fabric layer and a melted plastic material, forming multiple recesses and protruding blocks in the lower mold, setting the depth of each one of the recesses 11, 11A and the height of each one of the protruding blocks at a ratio of 2:1 and dipping the fabric layer in a liquid resin. The forming step includes injecting the melted plastic material into the molds to form an outsole to enable the melted plastic material to fill into the recesses to form multiple non-slip protrusions. The separating step includes cooling the molds, separating the molds and getting the outsole with the embedded fabric layer out of the molds.

The present invention is a continuation-in-part of application Ser. No. 11/951,606, filed on Dec. 6, 2007.

### BACKGROUND OF THE INVENTION

1. Field of Invention

The present invention relates to a manufacturing method, and more particularly relates to a method of manufacturing an outsole with an embedded fabric layer that can provide a preferred non-slip effect and can reduce the cost of production.

2. Description of the Related Art

A conventional outsole is formed using plastics and rubbers. However, the conventional outsole may be slippery for lack of non-slip structures on the bottom surface of the conventional outsole. Additionally, the conventional outsole is made of plastic materials and the cost of production of the conventional plastic outsole is higher than outsoles comprising different materials including a cloth cover. Therefore, a footwear outsole is disclosed in U.S. Pat. No. 7,081,221, is made by a single injection mold and has an outsole, a fabric layer and a molded outsole layer. The molded outsole layer is formed between the outsole and the fabric layer by the injection mold. Although the fabric layer can reduce the cost of production, the fabric layer cannot provide a non-slip effect to the footwear outsole and this influences the non-slip effect of the footwear outsole.

In addition, a footwear outsole is disclosed in U.S. Pat. No. 7,313,876 and has a fabric layer, an outsole and multiple non-slip protrusions. The outsole is attached to a top surface of the fabric layer. The non-slip protrusions are formed integrally on a bottom surface of the outsole, are connected to each other and extend through the fabric layer and protrude out from the bottom surface of the outsole. Although the non-slip protrusions are connected to each other to form a non-slip layer on the bottom surface of the outsole, the whole non-slip layer may be separated from the outsole when one of the non-slip protrusions falls off the bottom surface of the outsole and this will influence the non-slip effect of the footwear outsole.

Furthermore, a shoe is disclosed in U.S. Pat. No. 2,931,110 and has an outsole, a fabric layer and multiple non-slip protrusions. The fabric layer has a top surface and multiple through holes. The through holes are individually formed through the fabric layer. The outsole is attached to a top surface of the fabric layer. The non-slip protrusions are formed integrally on the outsole and extend through the through holes of the fabric layer and protrude out from the fabric layer. Although the non-slip protrusions can be formed on and protrude from the fabric layer via the through holes, the through holes need to be formed before the non-slip protrusions are formed on the fabric layer and this will increase the cost of production and limit the sizes and shapes of the non-slip protrusions.

With reference to FIG. 6, when the melted plastic materials are embedded through the fabric layer 80 to form the non-slip protrusions 81 as above described, the fabric layer 80 is soft and is covered on a lower mold 90. The lower mold 90 has a top surface, multiple recesses 91 and multiple protruding blocks 92. The recesses 91 are formed in the top surface of the lower mold 90. The protruding blocks 92 are formed on and protrude from the top surface of the lower mold 90 around the recesses 91. When the fabric layer 80 is mounted on the top surface of the lower mold 90, the fabric layer 80 is held on and abuts the protruding blocks 92 and the top surface of the lower mold 90 due to the soft quality of the fabric layer 80. Then, multiple gaps 93 are formed between the fabric layer 80, the top surface of the lower mold 90 and the protruding blocks 92. When a melted plastic material 81 is injected into the recesses 91 of the lower mold 90 via the fabric layer 80, the melted plastic material 81 also passes through the fabric layer 80 and fills in the gaps 93 between the fabric layer 80 and the top surface of the lower mold 90 and this will influence the quality and the non-slip effect of the outsole.

To overcome the shortcomings, the present invention provides an outsole with an embedded fabric layer and a method of manufacturing the same to mitigate or obviate the aforementioned problems.

### SUMMARY OF THE INVENTION

The primary objective of the present invention is to provide a method of manufacturing an outsole with an embedded fabric layer that can provide a preferred non-slip effect and can reduce the cost of production.

The method of manufacturing an outsole with an embedded fabric layer in accordance with the present invention includes a preparing step, a forming step and a separating step. The preparing step includes preparing two molds, a fabric layer and a melted plastic material, forming multiple recesses and protruding blocks in the lower mold, setting the depth of each one of the recesses and the height of each one of the protruding blocks at a ratio of 2:1 and dipping the fabric layer in a liquid resin. The forming step includes injecting the melted plastic material into the molds to form an outsole to enable the melted plastic material to fill into the recesses to form multiple non-slip protrusions. The separating step includes cooling the molds, separating the molds and getting the outsole with the embedded fabric layer out of the molds.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a method of manufacturing an outsole with an embedded fabric layer in accordance with the present invention;

FIG. 2 is a perspective view of a first embodiment of an outsole with an embedded fabric layer in accordance with the present invention;

FIG. 3 is enlarged cross sectional and operational side views showing the forming step of the first embodiment of the outsole with an embedded fabric layer in FIG. 2 with molds;

FIG. 4 is a perspective view of a second embodiment of an outsole with an embedded fabric layer in accordance with the present invention;

FIG. 5 is enlarged cross sectional and operational side views showing the forming step of the second embodiment of the outsole with an embedded fabric layer in FIG. 4 with molds; and

FIG. 6 is enlarged cross sectional and operational side views showing the forming process of an outsole with an embedded fabric layer in accordance with the prior art with molds.

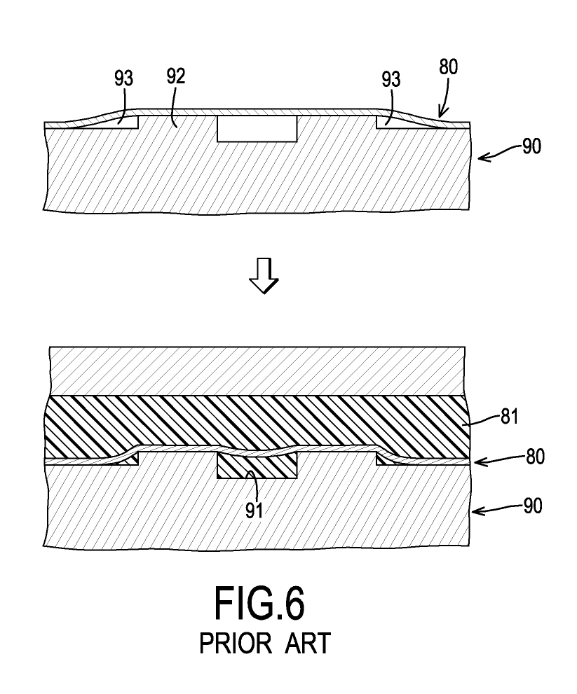

### DETAILED DESCRIPTION OF THE INVENTION

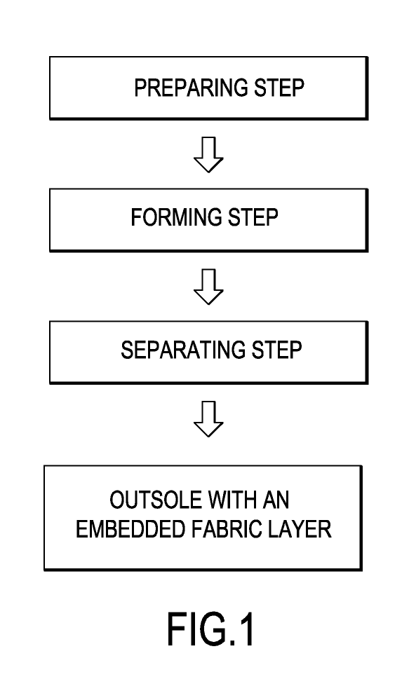

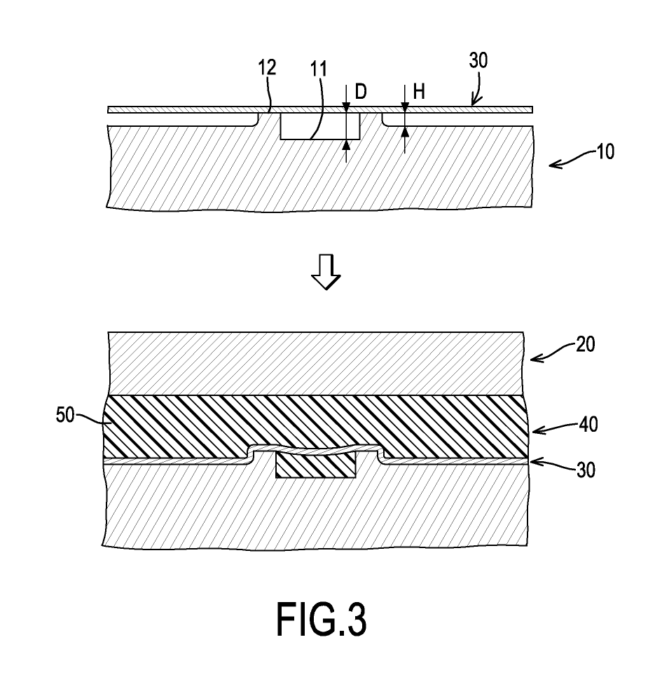

With reference to FIGS. 1 to 5, a method of manufacturing an outsole with an embedded fabric layer in accordance with the present invention comprises a preparing step, a forming step and a separating step.

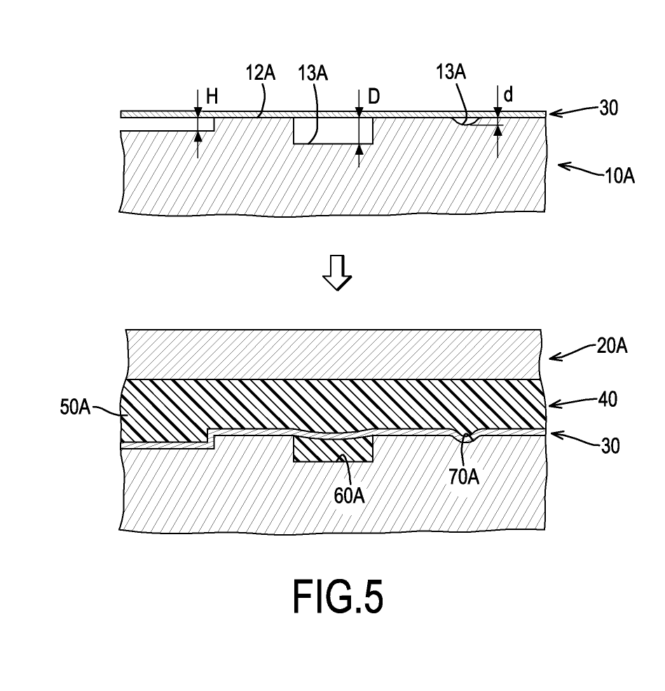

The preparing step comprises preparing a lower mold 10, 10A, an upper mold 20, 20A, a fabric layer 30 being porous and a melted plastic material 40, forming multiple recesses 11, 11A in a top surface of the lower mold 10, 10A, forming multiple protruding blocks 12, 12A on the top surface of the lower mold 10, 10A around the recesses 11, 11A to form a staircase structure, setting the depth (D) of each one of the recesses 11, 11A and the height (H) of each one of the protruding blocks 12, 12A at a ratio of 2:1 and dipping the fabric layer 30 in a liquid resin to enhance the hardness of the fabric layer 30. Preferably, the depth (D) of each one of the recesses 11, 11A is set under 0.6 millimeter and the height (H) of each one of the protruding blocks 12, 12A is set under 0.3 millimeter. In addition, each protruding block 12 has an advance angle formed between the top surface of the lower mold 10 and the protruding block 12. Preferably, with reference to FIG. 5, the preparing step comprises forming multiple detents 13A in the top surface of the lower mold 10A and setting the depth (D) of each one of the recesses 11A and the depth (d) of each one of the detents 13A at a ratio of 2:1.

The forming step comprises mounting the fabric layer 30 between the molds 10, 10A, 20, 20A, heating and keeping the molds 10, 10A, 20, 20A at the temperature between 150° C.-170° C., injecting the melted plastic material 40 into the molds 10, 10A, 20, 20A to form an outsole 50, 50A between the upper mold 20, 20A and the fabric 30, 10A, 20, 20A at a pressure between 50˜70 lb/ft² to enable the melted plastic material 40 to press the fabric layer 30 abutting the top surface of the lower mold 10, 10A around the protruding blocks 12, 12A and to enable the melted plastic material 40 to fill into the recesses 11, 11A of the lower mold 10, 10A via the fabric layer 30 to form multiple non-slip protrusions 60, 60A. Additionally, during the above mentioned injecting step, the heated molds 10, 10A, 20, 20A can make the resin that is formed on the fabric layer 30 melt to enable the melted plastic material 40 to fill into the recesses 11, 11A of the lower mold 10, 10A via the fabric layer 30. Preferably, with reference to FIG. 5, in the forming step, the melted plastic material 40 presses the fabric layer 30 on the top surface of the lower mold 10A at the detents 13A to form multiple patterns 70A and is embedded into the recesses 11A to form multiple non-slip protrusions 60A.

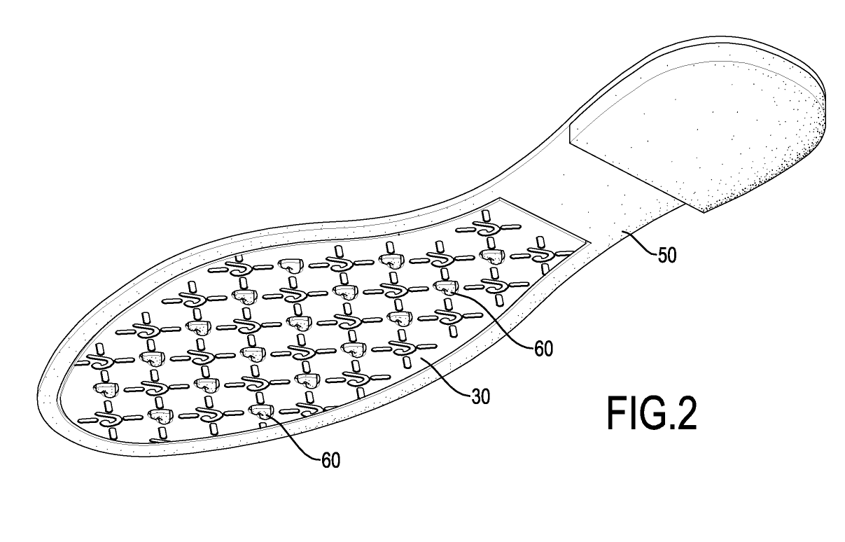

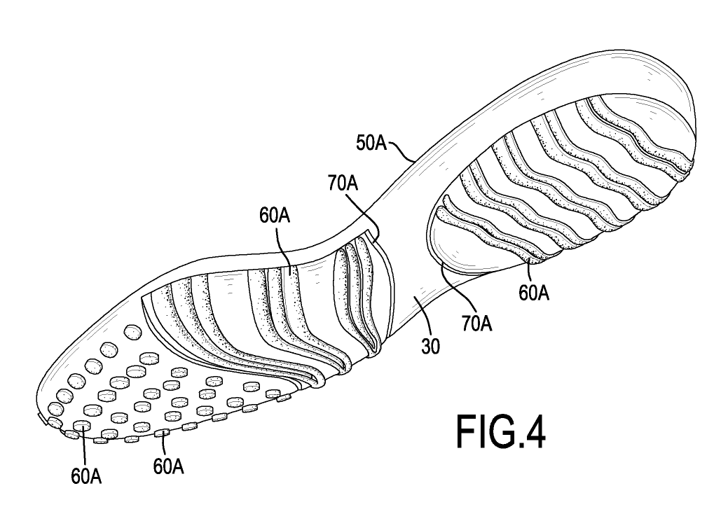

The separating step comprises cooling the molds 10, 10A, 20, 20A to room temperature, separating the molds 10, 10A, 20, 20A and getting the outsole 50, 50A with the embedded fabric layer 30 out of the molds 10, 10A, 20, 20A as shown in FIGS. 2 and 4.

With the method of manufacturing an outsole with an embedded fabric layer in accordance with the present invention, the outsole with an embedded fabric layer has a fabric layer 30 and an outsole 50, 50A.

The fabric layer 30 is porous, allows melted plastic materials 40 to pass through and has a top surface, a bottom surface, multiple embedding regions and multiple un-embedding regions. The embedding regions are individually formed on the bottom surface of the fabric layer 30 and each embedding region has a shape and a depth. The un-embedding regions are formed on the bottom surface of the fabric layer 30.

The outsole 50, 50A is made of melted plastic materials 40, is attached to the top surface of the fabric layer 30 and has a bottom surface, multiple non-slip protrusions 60, 60A and multiple patterns 70A. The bottom surface is attached to the top surface of the fabric layer 30. The non-slip protrusions 60, 60A are individually formed on and protrude from the bottom surface of the outsole 50, 50A, extend out of the embedding regions of the fabric layer 30 and each non-slip protrusions 60, 60A has a height and a shape corresponding to the shape of an embedding region of the fabric layer 30. The height of each one of the non-slip protrusions 60, 60A and the depth of each one of the embedding regions of the fabric layer 30 are set at a ratio of 2:1.The patterns 70A are formed on and protrude from the bottom surface of the outsole 50A to abut the top surface of the fabric layer 30 at the un-embedding regions, and each pattern 70A has a height. The height of each one of the non-slip protrusions 60, 60A and the height of each one of the patterns 70A are set at a ratio of 2:1.

When the outsole with an embedded fabric layer in accordance with the present invention is manufactured, the depth (D) of each one of the recesses 11, 11A and the height (H) of each one of the protruding blocks 12, 12A are set at a ratio of 2:1 and the depth (D) of each one of the recesses 11A and the depth (d) of each one of the detents 13A are also set at a ratio of 2:1. Accordingly, when the height (H) of each one of the protruding blocks 12, 12A and the depth (d) of each one of the detents 13A are set under 0.3 millimeter and the depth (D) of each one of the recesses 11, 11A is set under 0.6 millimeter, the melted plastic material 40 can be well controlled to pass through the fabric layer 30 or not to form the individual non-slip protrusions 60, 60A and the patterns 70A and this can provide a preferred non-slip effect to the outsole 50, 50A and can reduce the cost of production. In addition, the fabric layer 30 is dipped in a liquid resin to enhance the hardness of the fabric layer 30 and this can avoid forming multiple gaps between the fabric layer 30 and the top surface of the lower mold 10, 10A and this also can provide preferred non-slip effect to the outsole 50, 50A.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A method of manufacturing an outsole with an embedded fabric layer comprising:
a preparing step comprising:
preparing a lower mold, an upper mold, a fabric layer being porous and a melted plastic material;
forming multiple recesses in a top surface of the lower mold;
forming multiple protruding blocks on the top surface of the lower mold around the recesses to form a staircase structure;
setting the depth of each one of the recesses and the height of each one of the protruding blocks at a ratio of 2:1; and
dipping the fabric layer in a liquid resin to enhance a hardness of the fabric layer;
a forming step comprising:
mounting the fabric layer between the molds;
heating the molds;
injecting the melted plastic material into the molds, to form an outsole between the upper mold and the fabric layer to enable the melted plastic material to press the fabric layer abutting the top surface of the lower mold around the protruding blocks and to enable the melted plastic material to fill into the recesses of the lower mold via the fabric layer to form multiple non-slip protrusions; and
a separating step comprising:
cooling the molds; and
separating the molds; and
getting the outsole with the embedded fabric layer out of the molds.

2. The method of manufacturing an outsole with an embedded fabric layer as claimed in claim 1, wherein, in the forming step, the molds, are heated and kept at the temperature between 150° C.-170° C.

3. The method of manufacturing an outsole with an embedded fabric layer as claimed in claim 2, wherein, in the forming step, the melted plastic material is ejected into the molds, to form an outsole between the upper mold and the fabric layer, at a pressure between 50˜70 lb/ft² .

4. The method of manufacturing an outsole with an embedded fabric layer as claimed in claim 3, wherein
the preparing step further comprises:
forming multiple detents in the top surface of the lower mold; and
setting the depth of each one of the recesses and the depth of each one of the detents at a ratio of 2:1; and
the forming step further comprises:
pressing the fabric layer on the top surface of the lower mold at the detents by the melted plastic material to form multiple patterns; and
embedding the melted plastic material into the recesses to form multiple non-slip protrusions.

5. The method of manufacturing an outsole with an embedded fabric layer as claimed in claim 4, wherein, in the separating step, the molds are cooled to room temperature.

6. The method of manufacturing an outsole with an embedded fabric layer as claimed in claim 5, wherein, in the preparing step, the depth of each one of the recesses is set under 0.6 millimeter and the height of each one of the protruding blocks is set under 0.3 millimeter.

7. The method of manufacturing an outsole with an embedded fabric layer as claimed in claim 1, wherein, in the forming step, the melted plastic material is ejected into the molds, to form an outsole between the upper mold and the fabric layer at a pressure between 50˜70 lb/ft² .

8. The method of manufacturing an outsole with an embedded fabric layer as claimed in claim 1, wherein
the preparing step further comprises:
forming multiple detents in the top surface of the lower mold; and
setting the depth of each one of the recesses and the depth of each one of the detents at a ratio of 2:1; and
the forming step further comprises:
pressing the fabric layer on the top surface of the lower mold at the detents by the melted plastic material to form multiple patterns; and
embedding the melted plastic material into the recesses to form multiple non-slip protrusions.

9. The method of manufacturing an outsole with an embedded fabric layer as claimed in claim 1, wherein, in the separating step, the molds are cooled to room temperature.

10. The method of manufacturing an outsole with an embedded fabric layer as claimed in claim 1, wherein, in the preparing step, the depth of each one of the recesses is set under 0.6 millimeter and the height of each one of the protruding blocks is set under 0.3 millimeter.

11. The method of manufacturing an outsole with an embedded fabric layer as claimed in claim 1, wherein, in the preparing step, an advance angle is formed between each one of the protruding blocks and the top surface of the lower mold.

12. An outsole with an embedded fabric layer comprising:
a fabric layer being porous for allowing melted plastic materials to pass through and having
a top surface;
a bottom surface; and
multiple embedding regions individually formed on the bottom surface of the fabric layer and each embedding region having a shape and a depth; and
an outsole attached to the top surface of the fabric layer and having
a bottom surface attached to the top surface of the fabric layer; and
multiple non-slip protrusions individually formed on and protruding from the bottom surface of the outsole, extending out of the embedding regions of the fabric layer and each non-slip protrusions having
a height; and
a shape corresponding to the shape of an embedding region of the fabric layer.

13. The outsole with an embedded fabric layer as claimed in claim 12, wherein the height of each one of the non-slip protrusions and the depth of each one of the embedding regions of the fabric layer are set at a ratio of 2:1.

14. The outsole with an embedded fabric layer as claimed in claim 13, wherein
the fabric layer has multiple un-embedding regions formed on the bottom surface of the fabric layer; and
the outsole has multiple patterns formed on and protruding from the bottom surface of the outsole, compressed and abutting the top surface of the fabric layer at the un-embedding regions and each pattern having a height.

15. The outsole with an embedded fabric layer as claimed in claim 14, wherein the height of each one of the non-slip protrusions and the height of each one of the patterns are set at a ratio of 2:1.
